(19) United States
(12) Patent Application Publication
(10) Pub. No.: US 2020/0387935 A1
(43) Pub. Date: Dec. 10, 2020

(54) AUTOMATED DATA ANALYSIS AND PROCESSING FOR TARGETED ADVERTISING

(71) Applicant: Rolan REICHEL, Oakland, CA (US)

(72) Inventor: Rolan REICHEL, Oakland, CA (US)

(21) Appl. No.: 16/892,538

(22) Filed: Jun. 4, 2020

Related U.S. Application Data
(60) Provisional application No. 62/857,105, filed on Jun. 4, 2019.

(51) Int. Cl. G06Q 30/02; G06N 3/04

(52) U.S. Cl. CPC G06Q 30/0271; G06N 3/04; G06Q 30/0277; G06Q 30/0249; G06Q 30/0276; G06Q 30/0244

(57) ABSTRACT

Systems and methods relating to analysis of data for advertising purposes. A system ingests data from multiple sources and processes the data to result in data that has been classified, formatted, and is suitable for routing to an analysis module. The analysis module receives the processed data and analyzes the data to produce multiple results including groupings of customers based on common characteristics, efficacy of previous advertising campaigns, and correlations between various data sets. An aggregator module receives these multiple results and, based on user input, produces suggested parameters for advertising campaigns.

### RELATED APPLICATIONS

This application is a non-provisional patent application which claims the benefit of U.S. Provisional Application No. 62/857,105 filed on Jun. 4, 2019.

### TECHNICAL FIELD

The present invention relates to advertising. More specifically, the present invention relates to systems and methods relating to managing large data sets and analyzing these data sets for advertising purposes.

### BACKGROUND

The information technology and communications revolution of the late 20th and early 21st century has expanded mankind's ability to reach each other throughout the world. The rise of the Internet has also expanded our ability to communicate, relate, and interact with others of the same mind. Hand in hand with this is the generation of almost incalculable amounts of data as people share, dispense, and generate data about themselves, their interests, their businesses, and others.

This rise in available data, fuelled by the ubiquity of data gathering, presents an opportunity for advertisers to be able to target smaller and smaller segments of the population. Such segments can be defined by the commonality of characteristics between individuals and these commonalities maybe determined from the volumes of information and data generated from multiple sources. However, there currently are no systems that can conveniently ingest such large amounts of data and produce results that can be implemented by advertisers. The amount of data available is quite staggering and processing such vast amounts of data is beyond human abilities.

There is therefore a need for systems and methods that can use the available data for advertising purposes. Such systems and methods, preferably, allow easy access to the results of analyses of such data.

### SUMMARY

The present invention provides systems and methods relating to analysis of data for advertising purposes. A system ingests data from multiple sources and processes the data to result in data that has been classified, formatted, and is suitable for routing to an analysis module. The analysis module receives the processed data and analyzes the data to produce multiple results including groupings of customers based on common characteristics, efficacy of previous advertising campaigns, and correlations between various data sets. An aggregator module receives these multiple results and, based on user input, produces suggested parameters for advertising campaigns.

In a first aspect, the present invention provides a system for processing advertisement related data, the system comprising:
a data configuration module for receiving said advertisement related data and for identifying, routing, and classifying said advertisement related data;
an analysis module receiving outputs of said data configuration module, said analysis module being for analyzing said outputs;
an aggregation module receiving analysis results from said analysis module, said aggregation module being for producing recommended advertising strategies based on said analysis results;

wherein
said system receives said advertisement related data from a plurality of sources.

In another aspect, the present invention provides a method for processing advertiser related data, the method comprising:

a) receiving advertiser related data;

b) processing said advertiser related data to determine various consumer data in said advertiser related data;

c) for each consumer having consumer data in said advertiser related data, determining at least one consumer interest from said consumer data;

d) grouping a consumer profile with other consumer profiles when said consumer profiles detail a specific consumer interest for said consumer profiles to thereby result in multiple one interest based groups of consumer profiles, each of said interest based groups being groups of consumer profiles whose data indicates a specific shared interest between consumers associated with said consumer profiles;

e) storing said interest based groups of consumer profiles.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention; and

FIG. 2 is a flowchart detailing steps in a method according to another aspect of the present invention.

### DETAILED DESCRIPTION

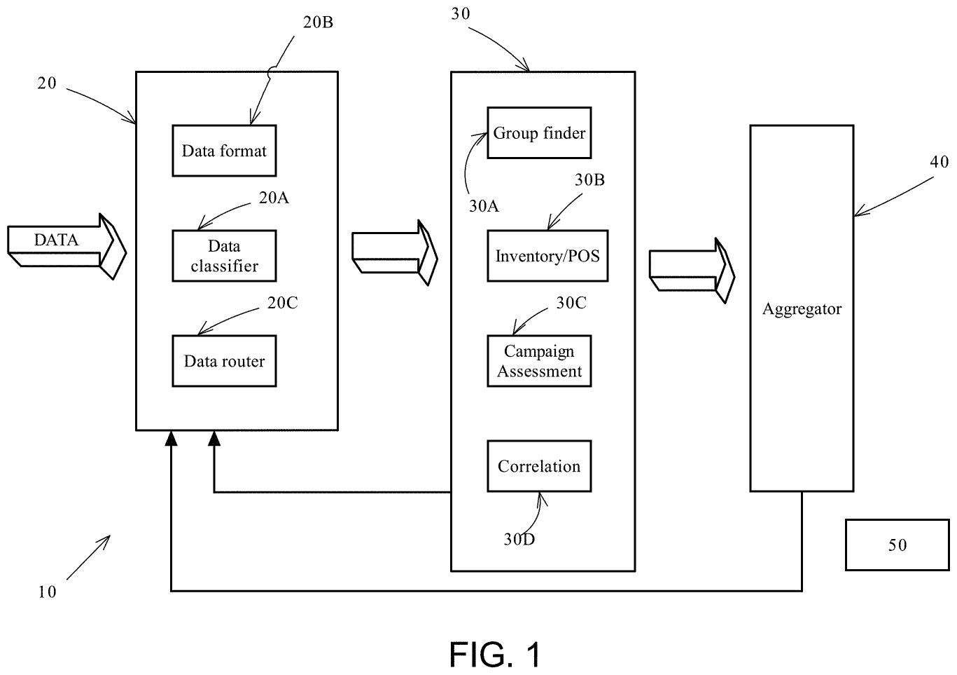

Referring to FIG. 1, a block diagram of a system according to one aspect of the present invention is illustrated. The system 10 includes a data processor module 20, an analysis module 30, and an aggregator module 40. The system works with the data processor module 20 receiving multiple different data sets from multiple sources. These data sets are then processed so that they are classified, formatted, and then routed to destinations in the analysis module 30. The analysis module 30 then analyzes multiple different groups of the processed data sets to determine multiple assessments of the combined data sets. The outputs of the analysis module are then routed to the aggregator module 40. The aggregator module 40 then takes the conclusions and results of the analyses of the analysis module 30 to create/determine advertising campaigns based on previous campaigns and on the conclusions of the analysis module 30. These campaigns and other results from the aggregator module 40 are then sent to a user. A database 50 can be used to store data sets or other data ingested by the system or to store previous analysis results.

In one implementation, the data processor module 20 includes a number of execution units for accomplishing specific tasks. As can be seen from FIG. 1, the data processor module 20 can include a classifier execution unit 20A, a data formatting execution unit 20B, and a data router execution unit 20C. The classifier execution unit 20A classifies incoming data sets into various categories (e.g. sales related data, social media derived customer data, inventory related data, advertising campaign related data, etc., etc.) so that the data sets can be routed to the proper section of the system for analysis. The data formatting execution unit 20B formats the data sets into one or more uniform data formats so that the data sets can be ingested and used by the analysis module 30. The data router execution unit 20C routes the data sets to the proper section of the analysis module so that the data sets can be properly used/analyzed.

Regarding implementation of the data processor module 20, the various execution units that form at least part of the data processor module 20 may be hardware/software units that use machine learning/artificial intelligence to learn their functions properly. As such, multiple training data sets can be used to train the execution units to route, classify, and format the various incoming data sets.

As can be seen from FIG. 1, the analysis module 30 uses multiple analysis units 30A-30D to perform analyses on the various formatted, classified, and routed data sets from the data processor module 20. In one implementation, the analysis module 30 has, among others, a group finder analysis unit 30A, an inventory/POS (point of sale) analysis unit 30B, a campaign assessment analysis unit 30C, and a correlation analysis unit 30D. It should be noted that these analysis units are examples and other analysis units may also be used. For clarity, the implementation illustrated in FIG. 1 uses multiple analysis units in parallel with each analysis unit being tasked with a specific analysis requiring specific types of data sets from the data processor module 20. These specific types of data sets are routed to the relevant analysis units from the data processor module's data router execution unit 20C.

To clarify the functions of the various analysis units 30A-30D in the implementation illustrated in FIG. 1, the group finder analysis module 30A receives customer data culled from POS data, social media derived data, and other customer related data sources. These data sets are then analyzed and common characteristics between different customers are extracted. Groups of these common characteristics between multiple customers are then aggregated together such that multiple customers all have these common characteristics. The groups of such common characteristics are then treated as defining a group of customers. Thus, as an example, 10 different characteristics are common to, for example, 30 customers from the various data sets. These 10 characteristics can then be defined as a group of customers. This group of customers can then be used for various purposes. As examples, the group can be targeted by an advertising campaign or the effect of an advertising campaign on this group can be assessed. The customers with the 10 common characteristics can be extracted from the various data sets and, where possible, their behaviour can be assessed to determine a campaign's effectiveness or to determine if these customers also have other defining actions/behaviours. Of course, the number of common characteristics that define a group of consumers can be as small as two or three individuals to an unlimited number of individuals. The size of such a group of consumers can be dependent upon the number of characteristics whose commonality among the group defines the group.

It should be clear that, in one implementation, the consumers can be grouped by their shared interests. This means that the incoming data is analyzed and groups are created for the various consumers whose data has been ingested by the system. Thus, as examples, a group for consumers who are interested in bicycling can be created or a group for consumers who are interested in a specific book may be created. A consumer may, simultaneously, be classified as being a member of multiple groups. While consumers may be grouped by demographics, the more important grouping would be those based on the shared interests of the consumers within a group. Thus, a defined group may be created by selecting a specific interest and then selecting multiple consumer profiles/data that show that a specific consumer is interested in or is participating in that specific interest. The consumers whose profiles show that they are interested in a specific interest are classified or categorized into specific groups. These specific groups can then be mined for more data. As an example, a group defined by an interest in gardening can be mined to determine what are the predominant demographics of the people within that group. Such data mining can show that, for example, the gardening group is mostly made up of women between the ages of 30 and 60. Each specific group can then have the group's predominant characteristics identified. This allows for faster identification of specific demographic groups. The interests of each demographic group can then be quickly determined by simply finding the interest groups whose demographic matches a desired demographic.

The inventory/POS analysis unit 30B can be configured to receive inventory data from an entity's warehouses as well as data from various point of sale systems. These data sets can then be analyzed by the inventory/POS analysis unit to determine for example, business health, whether to order more goods as inventory, wastage, and any other metrics that may be useful to a business. These metrics can then be used, along with the results of other analysis units, to determine if more advertising campaigns are necessary, which products to target for advertising campaigns, as well as to determine if a spike in sales/drop in inventory has occurred soon after an advertising campaign. Of course, such a spike/drop can be seen as a measure of an effectiveness of an advertising campaign.

The campaign assessment analysis unit 30C can be configured to receive advertisement campaign data (e.g. groups targeted, avenues for advertising, advertising budget, advertising used, etc., etc.), POS data, inventory data, customer data, and social media derived data. These data sets are then analyzed to determine how effective an advertising campaign has been. The effectiveness can be assessed on the basis of any number of predetermined metrics such as customer conversion, sales increase (or decrease), effect on customer engagement on social media, effect of the campaign on specific predefined groups, inventory decrease (or increase), effect on general customer engagement (with or without social media metrics), and effect of campaign on customer groups as defined by specific common characteristics among multiple customers. Of course, the foregoing are examples of how an advertising campaign can be assessed. Other methods of assessing advertising campaigns can be used including assessing campaigns based on other metrics and on other data sets. In some implementations, “effectiveness” can be defined as a numerical metric so that differing campaigns can be assessed against one another based on this numerical metric.

A correlation analysis unit 30D can also be present in the analysis module 30. The correlation analysis unit can receive all manners of data from the data processing module and determine if there are any correlations between the various data sets. As an example, there may be a correlation between customer ages and their engagement with social media, a correlation between customer spending habits and their location, etc., etc. These correlations can be output using a numerical basis (e.g. a rational number between 1 and 0) so that the strength or weakness of a correlation can be determined simply by assessing the number. Thus, if two data sets are strongly correlated, then their correlation may be assessed as 0.85 while a weak correlation may be assessed as 0.25. It should, however, be clear that correlation is not limited to between two data sets. Correlation may be assessed and determined between any number of data sets (e.g. assessing correlation between 3 data sets, 4 data sets, etc., etc.). As further examples, correlation may thus be assessed and determined between any of the following: cost per costumer/consumer acquisition, cost per order, cost per sales, conversion metrics, views, clicks, engagement, time on site and other engagement metrics.

Other analysis units are, of course, possible. One possible analysis unit is one for analyzing consumer engagement regarding one or more advertising campaigns. This analysis can be based on multiple criteria such as ad creative, creative units, type of advertisement placement, and the social media platform used for the advertising campaign.

Another possible analysis unit is that for analyzing prices, promotions, or other promotional offers. The prices for products and/or services being offered can be analyzed along with promotional offers relative to consumer/customer characteristics to determine which are the best (or most optimum) price points. As well, these can be analyzed to determine which promotional offers are most effective. The data sets to be analyzed can be from POS data, pricing data, as well as customer data and other data relating to customer characteristics and customer/consumer behaviour.

Yet a further possible analysis unit would be an analysis unit for determining any correlations between consumer characteristics and social media affinity characteristics. In addition to this, social media affinity characteristics can be used to determine any correlation between at least two other data sets. It should be clear that affinity characteristics refers to topics, books, movies, games, causes, etc., etc. that a consumer or user may have an affinity for. In other words, a consumer's affinity characteristics refer to things that that consumer likes, whether that consumer has expressly indicated that like or whether that like has been inferred from the consumer's other behaviours. Thus, affinity characteristics can include materials such as the books and movies that a consumer consumes, the groups that they like, places the like, etc., etc. These affinity characteristics can then be analyzed for correlations between what other things a consumer may like/want and that consumer's characteristics or behaviour.

It should be clear that affinity characteristics for consumers form part of the data sets for consumers or they can form their own data sets. These data sets can then be used as input to the various analysis units and can be the bases of analyses or conclusions.

To implement the above noted analysis units, the system may use machine learning to continuously train neural network-based analysis units. Training data sets may be used with the analysis units to ensure that the outputs of the analysis units are suitable for use by the system. Additionally, outputs from the analysis units that are suitable may be used for further training data sets to reinforce the suitable/acceptable results from the analysis units. Other types and/or forms of artificial intelligence may be used for the analysis units as necessary. In addition, while FIG. 1 illustrates multiple analysis units operating in parallel within the analysis module, the system may be configured such that a single configurable analysis unit is used with the configuration of the analysis unit being changed every time a different analysis/different inputs are used/desired. Conversely, instead of having a single analysis unit per type of analysis to be performed on the data, an analysis unit may have 2-3 different analysis types that it can perform. Then, depending on the data being sent to that analysis unit and the type of analysis to be performed, the configuration of the analysis unit may be adjusted/changed.

It should be clear that at least some of the outputs of the various analysis units may be fed back to the data processing module for processing and to enable the analyzed output to be used as input to other analysis units. As an example, the group finder analysis unit 30A may output multiple characteristics that define a specific group of customers/consumers to be targeted. This group of characteristics can then be fed back to the data processing module so that the group can operate as input to the campaign assessment analysis unit. The campaign analysis unit can then analyze a specific advertising campaign to determine the campaign's effect on the consumers who that the characteristics in the group of characteristics. Similarly, the correlation analysis unit may output a correlation between inventory and a certain age group of consumers. This correlation can be used as input to the campaign assessment analysis unit to determine if the correlation corresponds to a specific advertising campaign.

The final portion of the system is the aggregator module 40. The aggregator 40 receives the outputs from the analysis module and puts together these outputs into something useful to a user. As an example, the aggregator module 40 can receive the output of the campaign assessment analysis unit and the output of the group finder analysis unit to determine the most successful advertisement campaign and the group that has the highest chance of success for an advertising campaign. These two data points from the analysis module can then be aggregated into an advertising campaign targeted at a specific group for a high chance of a successful campaign. It should be clear that the aggregator module 40 can be user configurable to output suggested advertising campaigns, channels for the campaign, consumer/customer groups to target, or any other criterion that the user may wish for an upcoming advertising campaign. For example, the user may wish to launch an advertising campaign aimed at younger (under age 40) consumers who are active on social media. The user can configure the aggregator module to output suggested channels for the campaign (based on data from previous campaigns as sent to the data processor module), which groups to target (as defined by a group of variables or characteristics common to the consumers who would be in the group), and possibly a duration of the campaign for a user desired effectiveness.

It should be clear that the aggregator module 40 and its output would be dependent on the configuration of the system. As an example, the aggregator module may provide the user with the output of the group finder analysis unit and the user can select which group or groups to target. The user can also be provided with the output of the campaign assessment analysis unit so that the user can select which of previous campaigns can be implemented to target user selected groups. The user interface of the aggregator module can provide the user with multiple options as to the desired output for the module. The module can provide suggested advertising campaigns based on the inventory/POS data as well as user selected groups to target. Similarly, given a budget and a desired penetration of a specific group of consumers, the aggregator module can suggest an advertising campaign as well as a duration for such a campaign. The aggregator module can also provide the user with the results of the correlation analysis unit so that the user can see correlations between different data sets. Or, conversely, the aggregator module can use these correlations to generate the parameters of advertising campaigns. In one example, a user wants an advertising campaign for consumers of a specific age range and wants as effective a campaign as possible. If the correlation analysis unit determines that there was a correlation between a time that advertisements were shown and the same targeted consumers regarding engagement with the advertisement, the aggregator module can recommend that the advertising campaign use advertisements shown at a specific time to ensure maximum exposure to these targeted consumers.

Accordingly, based on the above, the aggregator module can provide the user with suggestions for parameters of advertisement campaigns including timing of the advertisements, channels for the advertisements, groups of consumers to be targeted (including age, gender, socio-economic status, etc. of the consumers), budgets for the campaign, duration of the campaign, products or product lines or services to be the subject of the campaign, and elements to be used in the campaign. Other parameters to be suggested by the aggregator module are, of course, possible.

In one specific implementation, the aggregator module can take into account the various interest based groups for which data has been collected. The aggregator module can determine the desired target audience for an advertising campaign and, by correlating that target audience's projected or known interests or demographics, the aggregator module can select one or more interest based groups to include in the suggestions for the user. Thus, if the target audience for an advertising campaign comprises women between the ages of 30 and 40 and if the interest based group relating to crocheting has a predominant demographic of women between the ages of 29 and 38, then, even though the parameters do not exactly coincide, the aggregator module can include that specific interest based group in the target groups for the next advertising campaign for the same product/service offering. Of course, the aggregator module and the other analysis modules may also analyze/include the resulting interest based groups in their analyses and/or suggestions.

The data received and processed by the system can be data that is social media derived, advertising campaign data (including parameters of previous advertising campaigns such as budgets, duration, targeted segments/consumers), results of previous campaigns, point-of-sale data (including customer identifiers or customer characteristics), inventory data, survey results data, census data, data from credit card companies, subscription data, communications related data (including mobile and Internet subscription data), address data, and other data and data sets that may be freely available to the public or which may be purchased from data mining organizations or data gathering organizations. Such data may include data from point of sale platforms, warehouse management systems, retail systems, websites, audience data from sources such as Google Analytics™, Facebook™, Shopify™ Pinterest™, data management platforms, and CRM systems such as Salesforce and others, and may include audience segments, client lists, addresses, email addresses, and phone numbers. The data ingested by the system may include data from social media that can be analyzed to determine each consumer's interests and/or demographic. Of course, such data will be identity agnostic as in each consumer's data is stripped of anything that can be an indication of the user's identity. While each consumer's identity is protected by, preferably, stripping the data of identity markers or identity data, the data should contain indications of the user's interests. As noted above, this allows the consumer and his or her profile to be classified and/or categorized according to his or her interests.

The output of the system may be presented to a user by way of a website or a dedicated Internet/network-based portal such that the user can configure the desired outputs of the aggregator data and such that the user can be presented with the various options available through the user interface of the aggregator module. In some implementations, the user may be presented with the user interface by way of a mobile device, desktop computer, or any suitable data processing device including tablets, smart phones, network connected appliances, or Internet kiosks.

It should also be clear that the outputs of the analysis module and of the aggregator module may be fed back into the system such that these outputs can form the basis for training data sets. This way, the outputs of the analysis module and of the aggregator module can reinforce/retrain the various neural networks/artificial intelligence components of the system.

In some implementations, the outputs of the aggregator module may be implemented automatically as advertising campaigns applied to specific websites, publisher websites, or to the Internet in general. For such implementations, it is preferable that the user is able to define the duration, budget, and scope (i.e. a size of the campaign) of such automated campaigns. The results of such automated campaigns can, of course, be fed back to the system as further input for training/adjustment of the various components of the system. Such implementations can be used to validate/test the efficacy and/or usefulness of campaign parameters suggested by the system. Once the parameters have been determined to be effective, a more widespread and far-ranging implementation of the campaign can be launched.

The system can be used to advantage in targeting specific consumer profiles for advertising campaigns. As an example, an advertising campaign to target women between the ages of 30 and 40 located in the southwestern United States may be desired. As noted above, the system would have data from consumers that categorizes the consumers based on their interests and that determines the predominant demographic characteristics of those categorized consumers. Thus, by searching for interest-based groups whose predominant demographic characteristics include women between the ages of 30 and 40, then the interest-based groups to be targeted can be found. Not only that, but this allows for a more targeted interest-based campaign, e.g. instead of a campaign simply targeting women between the ages of 30 and 40, the campaign can be targeted toward consumers interested in gardening or consumers interested in crocheting. Thus, instead of a demographic centered campaign, an interest based campaign can be launched and this interest based campaign can be more focused on those interests.

The use of interest-based categorization also allows for machine learning methods and modules to be used to more effectively target consumers based on their interests. As an example, an advertising campaign for a certain product offering or service offering can be made more effective by mining the interest-based groups. Specifically, the data regarding the effectiveness of the campaign over a specific period of time can be used as the data set to train machine learning models to select more useful and effective consumer interests. Each iteration of the campaign (or each time period for the campaign) can provide training data sets that can be used by the model to select better groups to target for the next iteration of the advertising campaign. Of course, for the first few iterations, user selected interest-based groups (or point-of-sale based data or Google Analytics based data) can be the targets for the campaign so that suitable data sets can be obtained. Once a number of data sets have been obtained, these can form the basis for a training set for the machine learning model that selects groups for the subsequent campaigns.

The social media aspect of the present invention, especially with the use of the interest based categorization, allows for the system to determine which campaigns are to be directed to each consumer. By determining each consumer's interests from their social media feed or data, the system can assess existing advertising campaigns in light of that consumer's interests. The consumer can then be enrolled in or targeted for campaigns that align with or are in the same field as the consumer's interests. This can be used to ensure a more robust response to the various campaigns that the consumer may not otherwise have been enrolled in.

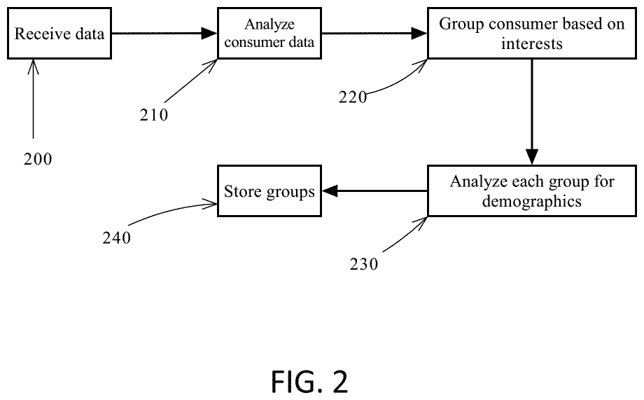

In one aspect, the present invention relates to a method for processing advertising related data. The steps in this method are illustrated in FIG. 2. In the first step, step 200, a data processing system receives advertising related data. This data may include consumer/user profiles which can be used to determine consumer preferences, consumer interest, and consumer demographics. Preferably, this data has been stripped of consumer identity data or any other data which may be used to trace/track/identify the specific consumer. In step 210, the data for each consumer is processed to determine each consumer's interests. This may include interests in specific sports, various leisure activities, entertainment preferences (e.g., movies, TV shows, music genres, book genres, book authors, book types, comics, etc.), work related activities, foods, food types, cuisine interests, health, health conditions, etc., etc. Once the consumer's interests have been determined from the data, the consumer profile for that consumer is categorized or classified into one or more interest based groups or interest based classifications or categories (step 220). As noted above, this may include simultaneously categorizing the consumer into multiple groups. For step 230, for each group, each member profile is analyzed to determine the predominant demographic characteristics for the members of that particular group. As an example, this may involve determining the age, gender, and general geographic location of the consumer. As noted above, this would not involve data that could be used to track/trace the consumer. The general or predominant demographics of each interest based group is then stored (step 240) and this data is updated as necessary whenever new consumer data is ingested by the system.

One the data for each specific interest group has been stored, that data can then be mined for data and, where necessary, used for advertising campaigns. If the data for each consumer allows that consumer's social media feeds to be targeted in an advertising campaign (without determining the consumer's identity), then the members of specific interest groups may be enrolled in or targeted for specific advertising campaigns where the product or service offering matches with or is related to the specific interest for that group. Similarly, if the predominant demographics of the specific interest group matches with or relates to a specific demographic to be targeted, then the members of that specific interest group may, again, be targeted or enrolled in a specific advertising campaign. The collected and analyzed data can now be used to manage/design interest based advertising campaigns. As noted above, this data can be used for online advertising and can be specific to specific social media platforms or to specific product/service areas or offerings.

It should be clear that the various aspects of the present invention may be implemented as software modules in an overall software system. As such, the present invention may thus take the form of computer executable instructions that, when executed, implements various software modules with predefined functions.

The system may be implemented as modules within a server or the various components may be implemented as separate servers that communicate with each other. As an example, the analysis module may be implemented as a server operating multiple instances of software implemented analysis units within that server. The data processing module can be implemented as another server implementing multiple software implemented execution units. Or, in another implementation, the system as a whole can be implemented as a single server.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for processing advertisement related data, the system comprising:
a data configuration module for receiving said advertisement related data and for identifying, routing, and classifying said advertisement related data;
an analysis module receiving outputs of said data configuration module, said analysis module being for analyzing said outputs;
an aggregation module receiving analysis results from said analysis module, said aggregation module being for producing recommended advertising strategies based on said analysis results;
wherein
said system receives said advertisement related data from a plurality of sources.

2. The system according to claim 1, wherein said analysis module comprises a plurality of analysis units, each of said analysis units being for receiving at least one data set from said data configuration module and for analyzing said at least one data set.

3. The system according to claim 2, wherein said plurality of analysis units includes at least one of:
an analysis unit for determining an effectiveness of an advertising campaign;
an analysis unit for determining groups of consumers with a plurality of common characteristics;
an analysis unit for determining an effectiveness of a social media-based advertising campaign;
an analysis unit for determining characteristics of consumers based on point-of-sale data;
an analysis unit for determining characteristics of consumers based on social media derived data;
an analysis unit for correlating point of sale data and inventory data with at least one data set relating to consumer characteristics;
an analysis unit for determining consumer engagement for an advertisement campaign based on social media gathered data;
an analysis unit for determining correlations between at least two data sets from said data configuration module;
an analysis unit for determining consumer engagement for at least one advertising campaign based at least one of: ad creative, creative unit, and social media platform;
an analysis unit for determining at least one of: effective pricing, promotion, and other offer of a product, said determining being based at least on at least one data set relating to consumer characteristics;
an analysis unit for determining correlations between consumer characteristics and social media affinity characteristics; and
an analysis unit for determining correlations between any two data sets based on social media affinity characteristics.

4. The system according to claim 2, wherein results from at least one of said plurality of analysis units is fed back to said data configuration module.

5. The system according to claim 1, wherein said aggregation module produces suggested parameters for advertising campaigns based on results from said analysis module.

6. The system according to claim 5, wherein said parameters for advertising campaigns includes at least one of:
a duration of said advertising campaign;
channels of distribution for said advertising campaigns;
at least one group of consumers to be targeted for said advertising campaigns;
a budget for said advertising campaigns;
at least one product that is to be a subject of said advertising campaigns;
at least one line of products that are to be a subject of said advertising campaigns;
at least one service that is to be a subject of said advertising campaigns; and
at least one affinity characteristic related to a consumer or data set.

7. The system according to claim 1, wherein said analysis module comprises at least one neural network-based analysis unit.

8. The system according to claim 1, wherein said analysis module comprises at least one machine learning based analysis unit.

9. The system according to claim 1, wherein said data configuration module comprises at least one execution unit, said at least one execution unit being at least one of:
a routing execution unit;
a data configuration execution unit; and
a data classifier execution unit.

10. The system according to claim 1, wherein said advertising related data comprises at least one of:
advertisement campaign data;
point of sale data;
inventory data;
customer data;
social media derived data;
sales data;
customer survey data;
census data; and
demographic based data.

11. The system according to claim 1, wherein said system categorizes data for each consumer based on said consumer's interests.

12. A method for processing advertiser related data, the method comprising:
a) receiving advertiser related data;
b) processing said advertiser related data to determine various consumer data in said advertiser related data;
c) for each consumer having consumer data in said advertiser related data, determining at least one consumer interest from said consumer data;
d) grouping a consumer profile with other consumer profiles when said consumer profiles detail a specific consumer interest for said consumer profiles to thereby result in multiple one interest based groups of consumer profiles, each of said interest based groups being groups of consumer profiles whose data indicates a specific shared interest between consumers associated with said consumer profiles;
e) storing said interest based groups of consumer profiles.

13. The method according to claim 12, further comprising processing at least one of said interest based groups to determine demographics of members of said at least one of said interest based groups.

14. The method according to claim 13, further comprising assessing existing advertising campaigns to determine if any of said interest based groups has demographics which match target audiences of said existing advertising campaigns.

15. The method according to claim 12, further comprising using said interest based groups to create interest based advertising campaigns.
